(19) United States
(12) Patent Application Publication
(10) Pub. No.: US 2017/0027382 A1
(43) Pub. Date: Feb. 2, 2017

(54) Vertical Grill Assembly

(71) Applicant: Burton Firtel, Boca Raton, FL (US)

(72) Inventor: Burton Firtel, Boca Raton, FL (US)

(21) Appl. No.: 15/224,820

(22) Filed: Aug. 1, 2016

Related U.S. Application Data
(60) Provisional application No. 62/198,810, filed on Jul. 30, 2015.

(51) Int. Cl. A47J 37/06

(52) U.S. Cl. CPC A47J 37/0688

(57) ABSTRACT

A vertical grill assembly. The vertical grill assembly includes a housing having a base, a rear wall, opposing sidewalls, and a top panel defining an interior volume. A plurality of burners are disposed on the interior surface of each opposing sidewall. The vertical grill assembly further includes a grill rack assembly including a first grill rack hingedly secured to a second grill rack via a floating hinge. Food is securable between the first grill rack and second grill rack via a locking ring that holds the first and second grill racks together. The grill rack assembly is insertable into the interior volume and is supported therein via upper and lower rails disposed on upper and lower ends of the sidewalls. The vertical grill assembly allows food to be prepared quickly and efficiently due to the simultaneous application of heat to both sides of the food.

### CROSS REFERENCE TO RELATED APPLICATIONS

This application claims the benefit of U.S. Provisional Application No. 62/198,810 filed on Jul. 30, 2015. The above identified patent application is herein incorporated by reference in its entirety to provide continuity of disclosure.

### FIELD OF THE INVENTION

The present invention relates to grill assemblies. More specifically, the present invention provides a vertical grill assembly having burners disposed in a vertical orientation on opposing sidewalls in order to apply heat to both sides of food simultaneously.

### BACKGROUND OF THE INVENTION

Many individuals utilize grills to prepare food. Grilling cooks food by applying direct heat via an open flame. The open flame heats the interior of the grill, directly heats the food, and heats the grating on which the food rests. This allows food to be cooked more quickly than with indirect heating methods such as oven cooking. Grills are also utilized to cook food because they impart a distinct taste due to the food being in direct contact with an open flame.

One drawback to traditional grills is that the heat source is typically applied from a single direction, such as a burner placed below a grill grate. In order to evenly cook food, a user must flip the food so that heat is applied to each side. This can be time consuming and may result in uneven cooking if each side of the food is facing the burner for a different amount of time. When the food is flipped and disturbed, the food is likely to fall apart or become less appetizing. Further, fat and other drippings often drip from the food onto the flame below the grate. This often causes flare-ups, which can potentially burn the food or even the user.

Devices have been disclosed in the prior art that relate to grill assemblies. These include devices that have been patented and published in patent application publications. These devices generally relate to home and commercial grill assemblies, such as U.S. Pat. No. 8,490,614, U.S. Published Patent Application Number 2008/0289619, U.S. Pat. No. 4,055,677, U.S. Pat. No. 6,041,695, and U.S. Pat. No. 8,573,117.

These prior art devices have several known drawbacks. These devices fail to allow a user to prepare food with heat sources directed at each side of the food. The prior art devices also fail to provide a vertical grill assembly having two racks wherein food is securable between each rack. Further, the prior art grill assemblies do not allow vertical orientation of food in order to allow excess drippings from the food to be drained.

In light of the devices disclosed in the prior art, it is submitted that the present invention substantially diverges in design elements from the prior art and consequently it is clear that there is a need in the art for an improvement to existing grill assemblies. In this regard the present invention substantially fulfills these needs.

### SUMMARY OF THE INVENTION

In view of the foregoing disadvantages inherent in the known types of grill assemblies now present in the prior art, the present invention provides a vertical grill assembly wherein the same can be utilized for providing convenience for the user when grilling food. The vertical grill assembly comprises a housing having a base, a rear wall, a pair of opposing sidewalls, and a top plate defining an interior volume. A plurality of burners are disposed on an interior surface of each opposing sidewall. A first pair of rails disposed on the interior surface of each opposing sidewall, wherein the each of the first pair of rails is parallel to one another. The vertical grill assembly further includes a grill rack assembly having a first rack and a second rack secured to one another at a first end via a floating hinge, and each having a handle extending from an opposing end. A locking ring is configured to receive each of the first grill rack handle and second grill rack handle in order to maintain the grill rack assembly in a closed configuration, with food secured between the first and second racks. The at least one pair of rails is configured to support the flanges of the grill rack within the interior volume of the housing.

One object of the present invention is to provide a vertical grill assembly having all of the advantages and none of the disadvantages of prior art grill assemblies.

Another object of the present invention is to provide a vertical grill assembly having a grill rack consisting of a first grill rack hingedly attached to a second grill rack, wherein food is securable between the first and second grill racks via a locking ring that holds the racks together.

A further object of the present invention is to provide a vertical grill assembly configured to apply heat to two sides of an article of food, allowing the food to be prepared quickly and efficiently.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of vertical grill assembly according to the present invention having the grill rack assembly partially inserted therein.

FIG. 2 shows a cross-sectional view of the interior of a vertical grill assembly according to the present invention.

FIG. 3 shows a side view of the grill rack assembly portion of a vertical grill assembly according to the present invention.

FIG. 4 shows a perspective view of a vertical grill assembly according to the present invention having the grill rack assembly fully inserted therein.

### DETAILED DESCRIPTION OF THE INVENTION

Reference is made herein to the attached drawings. Like reference numerals are used throughout the drawings to depict like or similar elements of the vertical grill assembly. For the purposes of presenting a brief and clear description of the present invention, the preferred embodiment will be discussed as used for preparing foods by applying even heat to both sides at the same time. The figures are intended for representative purposes only and should not be considered to be limiting in any respect.

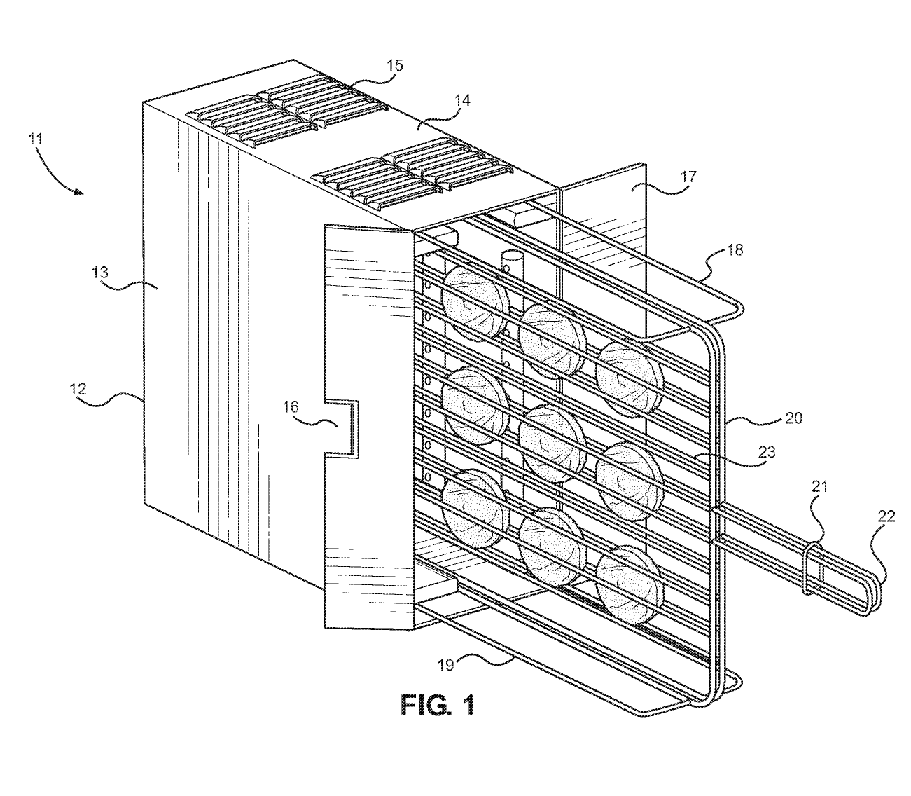

Referring now to FIG. 1, there is shown a perspective view of a vertical grill assembly according to the present invention having the grill rack assembly partially inserted therein. The vertical grill assembly 11 includes a housing 12 having a pair of opposing sidewalls 13, a rear wall (not visible), and a top panel 14. A grill rack assembly comprising pair of grill racks 20 is insertable into the housing 12 through an open front portion thereof. Each grill rack portion 20 includes a plurality of rods 23 disposed parallel to one another extending from a first end of the grill rack to a second end of the grill rack. In use, food is supported between each of the grill racks 20 of the grill rack assembly. The grill racks 20 are held together via a locking ring 21 that is placed over a handle 22 that extends outwardly from first end of the grill racks 20.

A plurality of vents 15 are disposed on the top panel 14. Each vent 15 includes multiple openings that allow smoke and steam from the interior of the housing 12 to escape during cooking. In the illustrated embodiment, the plurality of vents 15 are divided into two groups. A first group of vents is positioned toward a front end of the top panel 14 while the second group of vents is positioned toward the rear end of the top panel 14. This particular distribution of the plurality of vents 15 allows for smoke and steam to escape from the interior of the housing 12 in a uniform fashion.

Each of the grill racks 20 includes a pair of flanges 18 thereon. The flanges 18 are disposed on opposing sides of each grill rack 20. The flanges 18 extend perpendicularly with respect to the rod 23 portion of each grill rack 20. The grill racks 20 are secured to one another such that the flanges 18 from one grill rack 20 extends in a direction opposing the flanges 18 from the other grill rack 20.

The interior of the housing 12 includes a pair of upper rails 28 and a pair of lower rails 29. The upper and lower rails 28, 29 are disposed on an interior portion of the opposing sidewalls 13. When the grill rack assembly is inserted into the housing 12, an uppermost flange of the pair of flanges 18 of each grill rack 20 is supported by the upper rail 28. The lowermost flange of the pair of flanges 18 slides under the lower rail 29 when the grill racks 20 are situated within the housing 12. This prevents excessive movement of the grill rack assembly when it is inserted into the housing 12. The lower rails 29 prevent upward movement while the upper rails 28 prevent downward movement of the grill racks 20. In an alternate embodiment, the lowermost flange rests on top of the lower rails 29, providing additional space between the base of the housing 12 and the food therein for heated air to occupy.

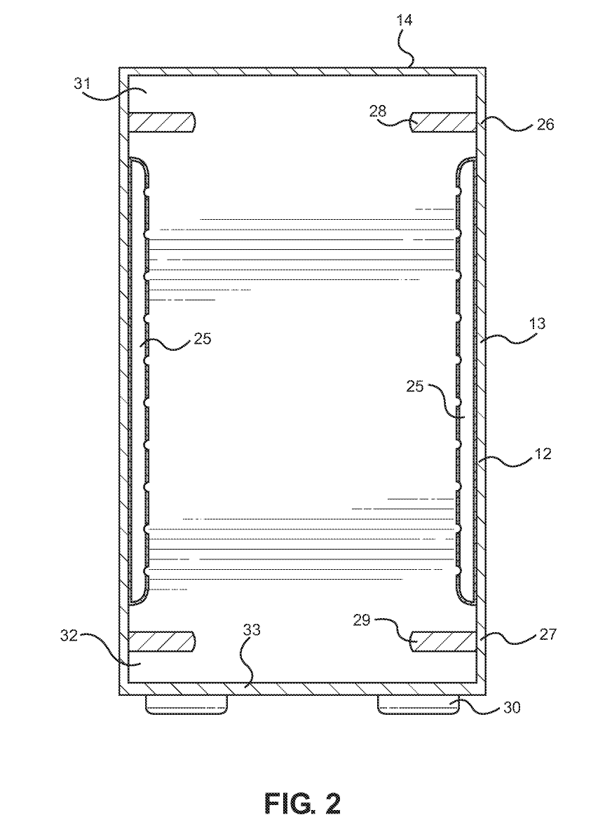

Referring now to FIG. 2, there is shown a cross-sectional view of the interior of a vertical grill assembly according to the present invention. A plurality of burners 25 are disposed on an inner side of the opposing sidewalls 13 of the housing 12. The plurality of burners 25 may be disposed in a variety of configurations in order to provide different patterns of emitted flame, which can affect the speed and evenness of cooking. In the illustrated embodiment, the plurality of burners 25 are disposed in such a way that the individual burners are parallel to one another. The burners 25 emit flame therefrom, preferably in such a manner that a sheet of flame along the inner side of the sidewalls 13 is formed, allowing for even distribution of heat.

The upper rails 28 are disposed on an upper end 26 of the interior housing 12, while the lower rails 29 are disposed on a lower end 27 thereof. The upper rail 29 supports the flanges of the grill rack thereon, and the grill rack flange occupies an open upper portion 31 between the top panel 14 and the first rail 28. The lower grill rack flange occupies an open lower portion 32 between the lower rail 29 and the base 33 of the housing 12. The configuration of the upper and lower rails prevents upward and downward movement of the grill rack assembly when inserted in the housing of the vertical grill assembly.

In the illustrated embodiment, the base 33 of the housing 12 comprises supports 30 thereon. The supports 30 are configured to support the housing 12 on a substantially horizontal surface such as a tabletop or rolling cart. The supports 30 may be composed of a non-slip material such as rubber in order to prevent accidental lateral movement of the housing 12. In an alternate embodiment, the base 33 comprises castor wheels thereon. The castor wheels allow users to easily roll the vertical grill assembly to a different position without requiring the user to lift the vertical grill assembly.

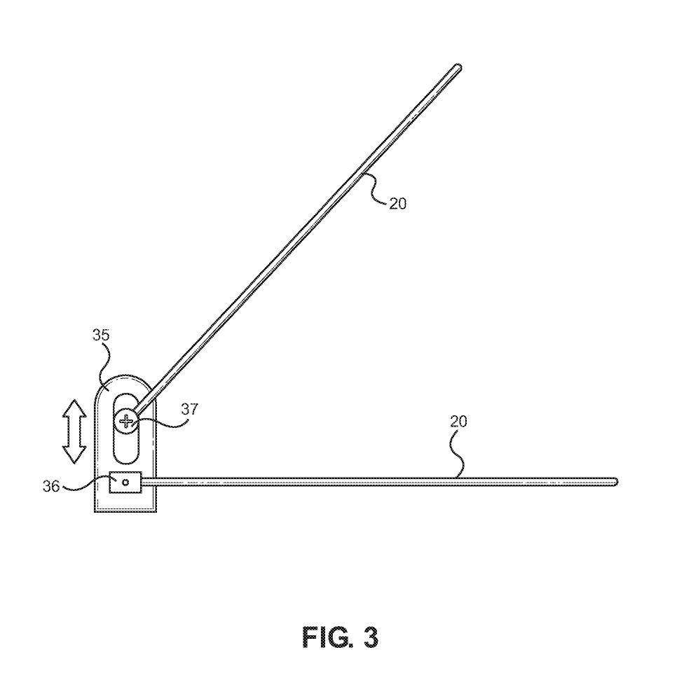

Referring now to FIG. 3, a side view of the grill rack portion of the vertical grilling assembly according to the present invention is shown. Each opposing grill rack 20 is connected at one end to a hinge housing 35. One of the grill racks 20 is fixedly connected to a lower portion 26 of the hinge housing. The opposing grill rack 20 is attached to a sliding member disposed within a channel 37 of the hinge housing 35 in sliding engagement therewith, forming a floating hinge. The sliding member slides up and down along the channel, and the resting position of the sliding member is dependent on the thickness of the food placed between the grill racks 20.

A spring force is applied to the sliding member of the floating hinge, which may be accomplished by an integrated spring disposed therein. The spring force is applied in a direction from one grill rack 20 toward the opposing grill rack 20 in order to secure food therebetween. The spring bias causes pressure to be applied to either side of the food inserted between the grill racks 20, while the locking ring closes the other end of the grill racks 20.

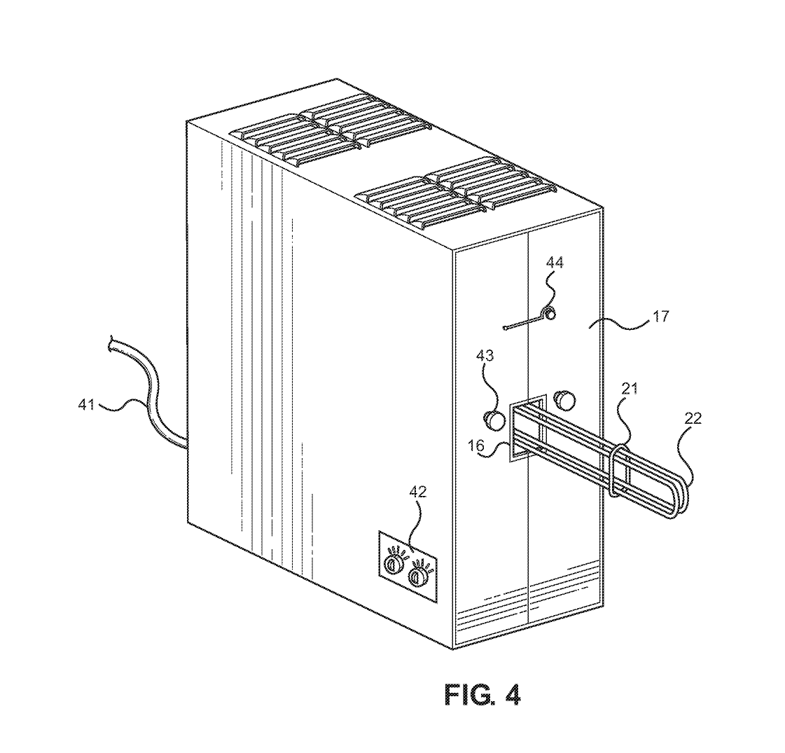

Referring now to FIG. 4, there is shown a perspective view of a vertical grill assembly according to the present invention having the grill rack assembly fully inserted therein. The vertical grill assembly further includes a gas line 41 connected to the plurality of burners at one end. An opposing end of the gas line 41 is connectable to an external fuel source (not shown) such as a propane tank. The illustrated embodiment of the invention utilizes propane gas as a fuel source; however, other suitable fuel sources may be contemplated. A control 42 is disposed on the housing of the vertical grill assembly. In an alternate embodiment, the control 42 may be disposed on a surface other than the housing such as a flat base surface or support stand. The control 42 is configured to adjust the output of the plurality of burners, which allows the user to control the temperature within the housing. The control 42 may include additional functions such as a mechanism for automatically lighting the plurality of burners.

A pair of doors 17 close off the interior of the housing during cooking. Each of the pair of doors 17 has a cutout 16 configured to accept the handle 22 of the grill rack therethrough. Handles 43 are disposed on the doors 17 for easily opening and closing the same. The handles 43 preferably are formed from a heat resistant material in order to protect users from high temperatures. A locking mechanism, depicted herein as a latch 44, is disposed on an upper end of the door 17 is configured to maintain the doors 17 in a closed position covering the open front portion of the housing. In alternate embodiments, other locking mechanisms may be utilized, such as a locking hinge, magnetic closure, or sliding latch.

In operation, a user first places the food to be cooked between each of the grill racks and closes the grill racks toward one another. The user then secures the grill racks together at the handle end via the locking ring. The spring bias applied to the floating hinge at the opposing end of the grill racks allows the user to place foods of different thickness between the grill racks. After securing the food between the grill racks, the user inserts the grill racks into the housing, wherein the upper and lower rails secure the grill racks within the housing of the vertical grill assembly.

Once the grill racks are secured within the housing, the user may then utilize the control to adjust the heat output of the burners. During cooking, the user may wish to rotate the grill racks one or more times to provide a more evenly cooked finished product. The user may open the door, remove the grill racks, rotate the grill racks 180 degrees about an axis in the same direction as the handle, and reinsert the grill racks into the housing. Since the grill racks are identical in shape, they may be supported by the upper and lower rails of the housing when in either the rotated or the original position. When rotated, each side of the food is exposed to a different side of the housing, and in turn to a different section of burners. Since each burner output may vary based on many factors, the user may wish to flip the grates according to user preference. In this way, the user may prepare food quickly by heating both sides simultaneously, and may also precisely control the cooking process by rotating and reinserting the grill racks if necessary.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A vertical grill assembly, comprising:
a housing comprising a base, a rear wall, a pair of opposing sidewalls, and a top panel defining an interior volume, the interior volume having an open front portion;
a plurality of burners disposed on an interior surface of each opposing sidewall;
a first pair of rails disposed on the interior surface of each opposing sidewall, wherein the each of the first pair of rails is parallel to one another;
a grill rack assembly comprising a first grill rack and a second grill rack each having a first end
and a second end, wherein the first grill rack and second grill rack are hingedly secured to one another at the first end, and wherein each of the first grill rack and second grill rack comprise a handle extending from the second end; and wherein each of the first grill rack and second grill rack comprise a pair of flanges disposed on opposing sides thereof;
a locking ring configured to receive each of the first grill rack handle and second grill rack handle in order to maintain the grill rack assembly in a closed configuration and support food between the first grill rack and second grill rack;
wherein the at least one pair of rails supports one of the pair of grill rack flanges thereon.

2) The vertical grill assembly of claim 1, wherein the top panel further comprises a plurality of vents thereon.

3) The vertical grill assembly of claim 1, wherein each flange projects perpendicularly from each of the first and second grill racks.

4) The vertical grill assembly of claim 1, wherein the first grate and second grill racks are each connected to a floating hinge, wherein the floating hinge is slidably disposed within a channel of a hinge housing.

5) The vertical grill assembly of claim 1, wherein the floating hinge is biased within the channel such that the first grill rack is biased in a direction toward the second grill rack.

6) The vertical grill assembly of claim 1, wherein the base comprises a plurality of support legs thereon.

7) The vertical grill assembly of claim 1, further comprising a gas line in fluid communication with the plurality of burners, wherein the gas line is connectable to an external fuel source.

8) The vertical grill assembly of claim 1, further comprising a second pair of rails, wherein the at least one pair of rails is disposed at an upper end of the interior volume and the second pair of rails is disposed at a lower end of the interior volume.

9) The vertical grill assembly of claim 8, wherein the plurality of burners are disposed between the first pair of rails and the second pair of rails.

10) The vertical grill assembly of claim 1, wherein the housing further comprises an open front portion, and a pair of opposing door panels that are each hingedly connected to the pair of opposing sidewall.

11) The vertical grill assembly of claim 8, wherein each door panel comprises a cutout thereon, each cutout being sized to accept each of the handles of the first grill rack and second grill rack therethrough.

12) The vertical grill assembly of claim 1, further comprising a control disposed thereon, wherein the control is configured to adjust the plurality of burners in order control the intensity of the flame emanating therefrom.

13) The vertical grill assembly of claim 1, further comprising a locking mechanism on the door, wherein the locking mechanism is configured to maintain the door in a closed position.

14) The vertical grill assembly of claim 1, wherein the handle portion of the each of the first grill rack and second grill rack comprises a heat resistant material.
